(19) United States
(12) Patent Application Publication
(10) Pub. No.: US 2025/0076652 A1
(43) Pub. Date: Mar. 6, 2025

(54) EFFICIENT THIN CURVED LIGHTGUIDE WITH REDUCED REFLECTIVE INTERACTION

(71) Applicant: GOOGLE LLC, Mountain View, CA (US)

(72) Inventors: Ozan Cakmakci, Sunnyvale, CA (US); Eliezer Glik, San Francisco, CA (US)

(21) Appl. No.: 18/699,940

(22) PCT Filed: Sep. 30, 2022
(86) PCT No.: PCT/US2022/045304

§ 371 Date: Apr. 10, 2024

Related U.S. Application Data
(60) Provisional application No. 63/252,433, filed on Oct. 5, 2021.

(51) Int. Cl. G02B 27/01

(52) U.S. Cl. CPC G02B 27/0172; G02B 2027/013; G02B 2027/0178

(57) ABSTRACT

A non-planar lightguide directs a display light from an incoupler surface towards an eye of a user via a reduced number of internal reflective interactions with a world-facing surface of the non-planar lightguide and an eye-facing lens surface of the non-planar lightguide.

### BACKGROUND

Wearable electronic eyewear devices include optical systems that magnify a display image and deliver a virtual image into the field of view (FOV) of a user. In some cases, wearable electronic eyewear devices also allow the user to see the outside world through a lens or see-through eyepiece. Some wearable electronic eyewear devices incorporate a near-to-eye optical system to display content to the user. These devices are sometimes referred to as head-mounted displays (HMDs). For example, certain HMD designs include a light engine such as a microdisplay (“display”) positioned in a temple or rim region of a head wearable frame like a conventional pair of eyeglasses. The display generates images, such as computer-generated images (CGI), that are conveyed into the FOV of the user by optical elements such as curved lightguides deployed in the lens of the head wearable display frame.

In the field of optics, a combiner is an optical apparatus that combines two light sources. For example, an optical combiner may combine light transmitted from a microdisplay or other light engine directed to the combiner with environmental light originating from the real world outside of the combiner. Optical combiners are used in wearable display devices (which include HMDs, heads-up displays (HUDs), and near-eye displays), which allow a user to view computer-generated content (e.g., textual, graphical, or video content) superimposed over a user's environment and viewed through the HMD. The HMD enables a user to view the computer-generated content without having to significantly shift their line of sight. The wearable electronic eyewear device can therefore serve as a hardware platform for implementing augmented reality (AR) or mixed reality (MR), which are used interchangeably herein. Different modes of augmented reality include optical see-through augmented reality, video see-through augmented reality, or opaque (VR) modes.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example head-mounted display (HMD) employing a thin curved optical combiner through which images projected by the HMD are displayed with an enlarged field of view, in accordance with some embodiments.

FIG. 2 illustrates a full-field representation of display light being conveyed via a curved lightguide in accordance with some embodiments.

FIG. 3 illustrates a single-ray representation of a display light being propagated through an internal volume of a curved lightguide in accordance with some embodiments.

FIG. 4 illustrates a representative series of perceived images resulting from a successive combination of total internal reflection interactions and partial internal reflection interactions with a reflective surface of a curved lightguide in accordance with some embodiments.

FIG. 5 illustrates an example curved lightguide optimized to use fewer reflective interactions (bounces) of a display light traversing the curved lightguide, in accordance with some embodiments.

FIG. 6 illustrates a full-field representation of a display light being conveyed via an optimized curved lightguide in accordance with some embodiments.

FIG. 7 illustrates an example of a substantially transparent optical shell coupled to an eye-facing surface of a curved lightguide in accordance with some embodiments.

FIG. 8 illustrates a correspondence between angle of incidence and angle of reflectance of an example optical coating applied to a curved lightguide, in accordance with some embodiments.

FIG. 9 is a flow diagram of a method of transmitting ambient light through a world-facing and eye-facing surfaces of a non-planar lightguide while directing light received from a light engine through the non-planar lightguide, in accordance with some embodiments.

### DETAILED DESCRIPTION

Head-mounted displays (HMDs) potentially have multiple practical and leisure applications, but the development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively thick optical combiners.

The optical performance of an HMD is an important factor in its design; however, users also care significantly about aesthetics of wearable devices. Independent of their performance limitations, many of the conventional examples of wearable heads-up displays have struggled to find traction in consumer markets because, at least in part, they lack fashion appeal. Some wearable HMDs employ planar (flat) lightguides in planar transparent combiners and, as a result, appear very bulky and unnatural on a user's face compared to the sleeker and more streamlined look of typical curved eyeglass and sunglass lenses. Thus, it is desirable to integrate curved lenses with lightguides in wearable heads-up displays or eyewear in order to achieve the form factor and fashion appeal expected of the eyeglass and sunglass frame industry.

In designing an HMD, design and weight considerations advantageously suggest a thin optical combiner (on the order of about 2 mm in some embodiments described herein) and a minimal optical element count. These considerations imply challenges in terms of optical aberration correction and, therefore, image quality.

The term “lightguide,” as used herein, refers to an optical combiner using one or more of total internal reflection (TIR), specialized filters, or reflective surfaces to propagate a display light generated by a light engine from an incoupler of the lightguide towards an outcoupler of the lightguide (typically towards an eye of a human user when in operation as part of a wearable display device) via a number of internal reflective interactions of the display light within an internal volume of the lightguide. In general, the terms “incoupler” and “outcoupler” will be understood to refer to any type of optical structure utilized to direct the display light into or out of the internal volume of the lightguide, respectively. Such optical structures may include, as non-limiting examples: diffraction gratings, holograms, holographic optical elements (e.g., optical elements using one or more holograms), volume diffraction gratings, volume holograms, surface relief diffraction gratings, or surface relief holograms. In certain embodiments discussed herein, an incoupler may be formed as a substantially planar surface aligned with one or more display lights output by a light engine. In certain embodiments, an outcoupler may be implemented as a region of the lightguide without separate optical structures at which display light exits the lightguide to form an image for an eye of a user. In some embodiments a lightguide is implemented as part of a lens structure of a wearable display device having an eyeglass form factor.

A significant distinguishing property between planar (flat) and non-planar (e.g., curved) lightguides is that flat lightguide architectures typically require a collimator optic to inject light into total internal reflection for light propagation to the outcoupler. Accordingly, flat lightguides often implement partial mirror outcouplers as one-dimensional (1D) or two-dimensional (2D) pupil expanders. Each of these outcouplers is associated with various tradeoffs, such as vertical eyebox size vs. optical efficiency. As used herein, eyebox refers to the area in which output from a lightguide may be accurately perceived if the pupil of a human eye is within that eyebox. Alternative pupil expander choices, such as holographic or diffractive outcouplers, often do not resolve such tradeoffs. In flat lightguides, a collimator optic is typically placed between the light engine and the incoupler to inject display light into the lightguide for propagation along a path through the lightguide via total internal reflection (TIR). The display light propagates down the entire length of the lightguide towards the outcoupler via TIR. Therefore, the light reaching an eye of the user will have propagated through the entire length of the lightguide. In this known architecture that utilizes a classical flat lightguide with a collimator and without 2D pupil expansion, the vertical eyebox is reduced as the light propagates from the incoupler, through the lightguide, and traversing the eye relief distance (the distance from an outcoupler of the lightguide to the user's eye).

Embodiments described herein relate to a thin curved lightguide that magnifies a microdisplay for visual use and addresses the thickness reduction problem for optical transparency. In addition, such embodiments reduce the number of non-TIR interactions at the interfaces (borders) of the curved lightguide—with each such non-TIR interaction being associated with some loss of propagated light—and thereby increase optical efficiency. This approach yields aesthetically pleasing results (i.e., eyewear look) with a single optical element, and in certain embodiments achieves those results via a substantially planar incoupler surface without any optical incoupler structure (e.g., incoupler gratings) or reliance on a separate collimator, by advantageously selecting and configuring an angle at which the display light is projected at the substantially planar incoupler surface. Moreover, in certain embodiments display light propagating through the curved lightguide is output towards an eye of a user based on partial internal reflection without any separate outcoupling optical structure (e.g., outcoupler gratings).

In some embodiments, one or more optical coatings are disposed along portions of particular surfaces of the curved lightguide in order to increase the efficiency of the lightguide—that is, to ensure that a smaller proportion of a propagating display light is lost due to only partial internal reflection (PIR) at certain sites of interaction of the display light with those surfaces.

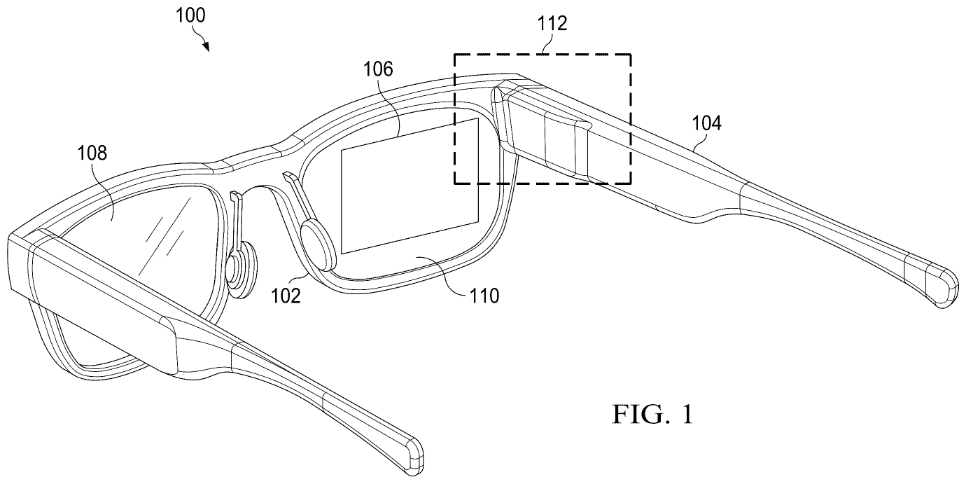

FIGS. 1-9 illustrate various aspects of curved lightguides (also referred to as waveguides) that employ a flat (substantially planar) surface incoupler, a spherical or freeform world-facing lens surface, and a spherical or freeform eye-facing lens surface to achieve a relatively large FOV for transmission of both display light and external environmental light in a thin form factor. The term “freeform” refers to a surface that does not have symmetry around any axis. In various embodiments, the lightguide has a gradient thickness of approximately 1 to 4 mm, and is capable of supporting a large eyebox of around 8 mm. The lightguide can be implemented in a variety of HMDs, including those with an eyeglass form factor.

FIG. 1 illustrates an example wearable near-eye display system 100 (referred to as display system 100) employing a thin, curved lightguide providing an enlarged field of view in accordance with some embodiments. In the depicted embodiment, the display system 100 has a support structure 102 that includes an arm 104, which houses a light engine (e.g., a microdisplay, a laser projector, a micro-LED projector, a Liquid Crystal on Silicon (LCOS) projector, or the like). The light engine is configured to project images toward the eye of a user via a lightguide, such that the user perceives the projected images as being displayed in a field of view (FOV) area 106 of a display at one or both of spherical lens elements 108, 110. In the depicted embodiment, the display system 100 is a near-eye display system in the form of a WHUD in which the support structure 102 is configured to be worn on the head of a user and has a general shape and appearance (that is, form factor) of an eyeglasses (e.g., sunglasses) frame.

In the depicted embodiment, the support structure 102 contains or otherwise includes various components to facilitate the projection of such images toward the eye of the user, such as a projector and a lightguide. In some embodiments, the support structure 102 further includes various sensors, such as one or more front-facing cameras, rear-facing cameras, other light sensors, motion sensors, accelerometers, and the like. In some embodiments, the support structure 102 includes one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1. It should be understood that instances of the term “or” herein refer to the non-exclusive definition of “or”, unless noted otherwise. For example, herein the phrase “X or Y” means “either X, or Y, or both”.

One or both of the spherical lens elements 108, 110 are used by the display system 100 to provide an augmented reality (AR) display in which rendered graphical content can be superimposed over or otherwise provided in conjunction with a real-world view as perceived by the user through the spherical lens elements 108, 110. For example, a projection system of the display system 100 uses light to form a perceptible image or series of images by projecting the light onto the eye of the user via a light engine of the display system, a lightguide formed at least partially in the corresponding spherical lens element 108 or 110, and one or more optical elements (e.g., one or more scan mirrors, optical relays, prisms, and the like), according to various embodiments.

One or both of the spherical lens elements 108, 110 includes at least a portion of a curved lightguide that routes display light received by an incoupler of the lightguide toward an eye of a user of the display system 100. The display light is modulated and projected onto the eye of the user such that the user perceives the display light as an image. In addition, each of the spherical lens elements 108, 110 is sufficiently transparent to allow a user to see through the spherical lens elements to provide a field of view of the user's real-world environment such that the image appears superimposed over at least a portion of the real-world environment.

In some embodiments, the light engine of the projection system of the display 100 is a digital light processing-based projector, a scanning laser projector, or any combination of a modulative light source, such as a laser or one or more light-emitting diodes (LEDs), and a dynamic reflector mechanism such as one or more dynamic scanners, reflective panels, or digital light processors (DLPs). In some embodiments, the light engine includes a microdisplay panel, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the light engine includes a Liquid Crystal on Silicon (LCOS) display panel. In some embodiments, a display panel of the light engine is configured to output light (representing an image or portion of an image for display) into the lightguide of the display system. The lightguide expands the light and outputs the light toward the eye of the user.

The light engine is communicatively coupled to the controller and a non-transitory processor-readable storage medium or memory storing processor-executable instructions and other data that, when executed by the controller, cause the controller to control the operation of the light engine. In some embodiments, the controller controls the light engine to selectively set the location and size of the FOV area 106. In some embodiments, the controller is communicatively coupled to one or more processors (not shown) that generate content to be displayed at the display system 100. The light engine outputs light toward the FOV area 106 of the display system 100 via the lightguide. In some embodiments, at least a portion of an outcoupler of the lightguide overlaps the FOV area 106.

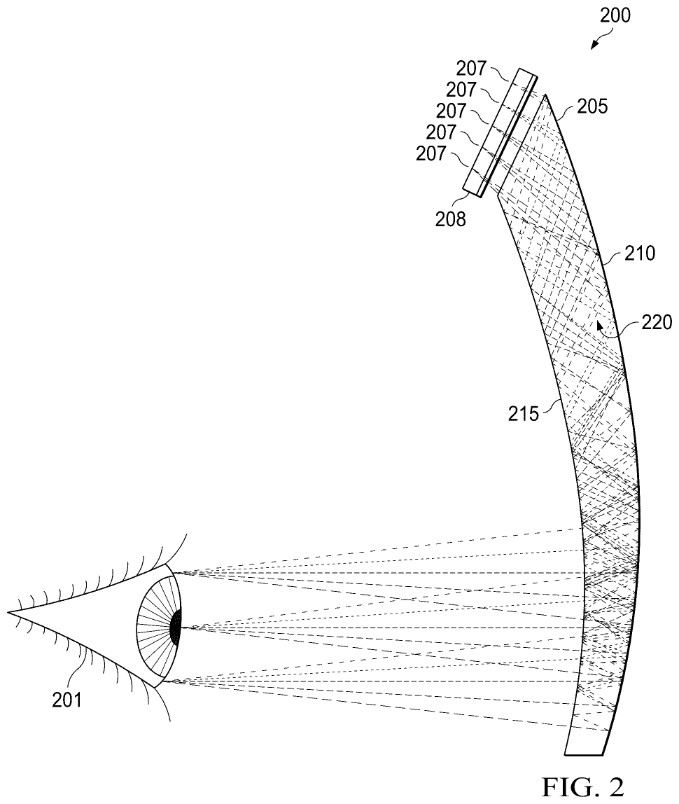

FIG. 2 illustrates a full-field representation of display light being conveyed via a curved lightguide 200. In the depicted representation, the curved lightguide 200 has a substantially planar incoupler surface 205, a world-facing surface 210, an eye-facing surface 215, and an internal volume 220. A light engine 208 directs multiple display lights 207 into the internal volume 220 of the curved lightguide 200 via the substantially planar incoupler surface 205. As illustrated, the display lights 207 are depicted as a set of five light beams (such as provided by individual pixels of a graphical display provided by the light engine 208) spaced positionally to represent a full field of light paths taken by the display light 207 as its light beams traverse and exit the internal volume 220 toward an eye 201 of a user. Each of the world-facing surface 210 and or eye-facing surface 215 may be a freeform surface or spherical surface. The curved lightguide 200 is implemented in a wearable heads-up display or other display system, such as the display system 100 of FIG. 1.

Although not shown in the example of FIG. 2, in some embodiments additional optical components are included in optical paths between the light engine 208 and the incoupler surface 205, or between the eye-facing surface 215 and the eye 201 (e.g., in order to shape the light for viewing by the eye 201). For example, in some embodiments, a prism (not shown) is used to steer light from the light engine into the incoupler surface 205 so that display light is coupled into the internal volume 220 at an angle appropriate to encourage propagation of the display light in lightguide 200 via TIR and/or Partial Internal Reflection (PIR). As another example, in some embodiments, a substantially transparent optical shell may be coupled to the eye-facing or world-facing surface of the curved lightguide 200 in order to correct optical aberrations (which may include one or more optical distortions, spherical aberrations, optical artifacts, or other optical aberrations) of world-side light passing through the curved lightguide 200, as described in greater detail elsewhere herein.

Ambient light from the real-world environment (not shown) that impinges on the world-facing surface 210 is transmitted through the lightguide 200 and the eye-facing surface 215 such that a user can see the real-world environment. In some embodiments, the combination of the world-facing surface 210 and the eye-facing surface 215 impart no optical power to the ambient light.

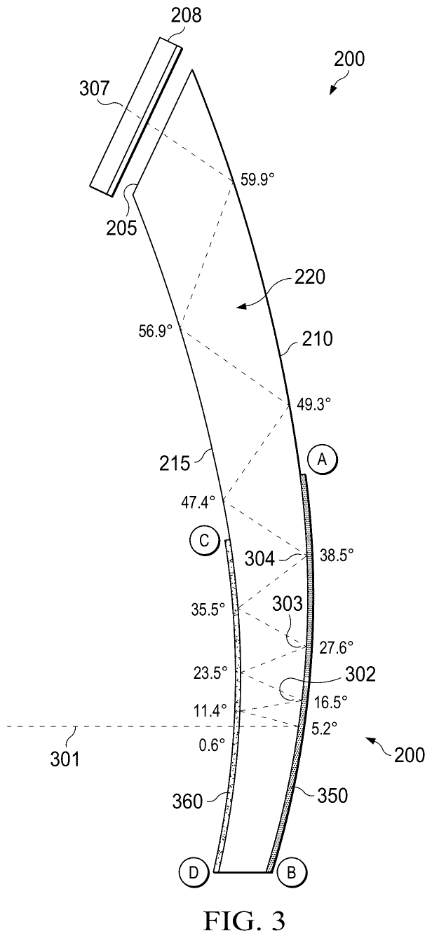

FIG. 3 illustrates a single-ray representation of a display light 307 being propagated through the internal volume 220 of the curved lightguide 200 via the incoupler surface 205. In contrast to the full-field representation of FIG. 2, the single-ray representation illustrates a single path of the display light 307 as it is transmitted into the internal volume 220 via the incoupler surface 205, and more easily illustrates a series of internal reflective interactions of the display light 307 with either the world-facing surface 210 or eye-facing surface 215 as the display light 307 propagates along the internal volume 220.

It will be appreciated that light impinging on the interface of a lightguide surface at an angle of incidence that is greater than a critical angle of the lightguide internally reflects within the lightguide via total internal reflection (TIR); in contrast, light impinging on the interface of the lightguide surface at an angle of incidence that is less than that critical angle experiences only partial internal reflection (PIR). The critical angle of the lightguide is a function of the refractive index of the lightguide material. In particular, in accordance with Snell's Law the critical angle of the lightguide is arcsin(1/n), where n is the refractive index of the lightguide material. For purposes of this example, the curved lightguide 200 has a refractive index of n=1.5, and therefore has a critical angle of arcsin(1/1.5)˜=41.8 degrees.

Following the path of the display light 307 after it passes into the internal volume 220 from the incoupler surface 205, the display light 307 first interacts with world-facing surface 210 at a 59.9° angle of incidence. As this angle of incidence is greater than the critical angle (41.8°) of the lightguide 200, the display light 307 experiences TIR at the interface of the world-facing surface 210 and is fully reflected by the world-facing surface 210 across the internal volume 220 to the next site of internal reflective interaction (bounce). Due to the curved nature of the lightguide 200, the angle of incidence is distinct at each such bounce: at the second bounce, the angle of incidence of the display light 307 with eye-facing surface 215 is 56.9°; at the third bounce, the angle of incidence with the world-facing surface 210 is 49.3°; at the fourth bounce, the angle of incidence with the eye-facing surface 215 is 47.4°.

Continuing to follow the path of the display light 307, a fifth bounce occurs at the world-facing surface 210 at an angle of incidence of 38.5°, which notably is less than the critical angle 41.8° of the lightguide 200. Accordingly, if only subject to the natural internal reflectivity of the lightguide 200, the display light 307 would partially exit the internal volume 220. However, in the depicted embodiment an optical coating 350 is disposed along a portion of the world-facing surface 210 in order to increase optical efficiency (that is, reduce the portion of display light lost) for PIR of the display light 307 at the fifth interaction site despite its less-than-critical angle of incidence of 38.5°. In certain embodiments, the reflective optical coating 350 is such that it provides relatively high reflectivity for interactions with light internal to the lightguide 200 while remaining substantially transparent to allow transmission of ambient light from the real world through the lightguide 200 towards an eye of a user. According to various embodiments, the optical coating 350 is implemented using one or more dielectrics, metals, or combinations of dielectrics and metals.

Still following the path of the display light 307 through the internal volume 220 of lightguide 200, a sixth bounce occurs at an angle of incidence of 35.5° with eye-facing surface 215; a seventh bounce occurs at an angle of incidence of 27.6° with the world-facing surface 210; an eighth bounce occurs at an angle of incidence of 23.5° with the eye-facing surface 215; a ninth bounce occurs at an angle of incidence of 16.5° with the world-facing surface 210; a tenth bounce occurs at an angle of incidence of 11.4° with the eye-facing surface 215; and an eleventh bounce occurs at an angle of incidence of 5.2° with the world-facing surface 210, after which the display light 307 encounters the eye-facing surface 210 at an angle of incidence of 0.6° (substantially perpendicular to the surface of the eye-facing surface of the lightguide 200), resulting in substantially all of the remaining display light 307 exiting the internal volume 220 towards the eye 201 of the user.

As noted above, in the depicted embodiment an optical coating 350 has been disposed along a portion of the world-facing surface 210 of lightguide 200 in order to increase the internal reflectivity of the lightguide 200 at that world-facing surface—that is, to limit a portion of the display light 307 that would otherwise be lost to the external world by passing through the external world-facing surface 210. Accordingly, in the depicted embodiment, the optical coating 350 has been disposed along a portion of the world-facing surface 210 that extends from a point A that is above (that is, closer to an end of the lightguide 200 proximal to the light engine 208) the fifth bounce site (the first having an angle of incidence with the world-facing surface 210 that is less than the critical angle of the lightguide 200) to a point B that is below (that is, closer to an end of the lightguide 200 that is distal from the light engine 208) the last bounce site with the world-facing surface 210 that occurs prior to the display light 307 exiting the lightguide 200 toward the eye 201 of the user (as shown in FIG. 2).

For similar reasons as those described above with respect to optical coating 350, a second optical coating 360 is disposed along a portion of the eye-facing surface 215 of the lightguide 200. In particular, the optical coating 360 has been disposed along a portion of the eye-facing surface 215 that extends from a point C that is above the fifth bounce site (the first having an angle of incidence with the eye-facing surface 215 that is less than the critical angle of the lightguide 200) to a point D that is below the site at which the remaining display light 307 exits the lightguide 200 toward the eye 201 (in FIG. 2). However, due to the need for the display light 307 to exit the lightguide 200 towards the eye 201 in as unimpeded manner as possible, it would be disadvantageous to dispose along the surface of eye-facing surface 215 an optical coating having similar reflectivity properties as the optical coating 350 disposed along the surface of world-facing surface 210. Therefore, in contrast to internal reflective interactions with the world-facing surface 210 and optical coating 350, internal reflective interactions of the display light 307 with the eye-facing surface 215 and optical coating 360 are less efficient—that is, they result in losing a greater portion of the display light 307.

Thus, at each reflective interaction with the interface defined by the optical coating 360, a portion of the display light 307 continues to propagate through the internal volume 220, but some portion of the display light 307 is also lost—that is, it passes externally through the interface defined by the optical coating 360. The lesser the angle of incidence with the eye-facing surface 215, the greater the respective portion of the display light 307 lost as a result of only partial internal reflection. As shown in the single-ray representation of FIG. 3, this externally lost portion of display light 307 results in multiple user-perceived instances of the display light 307 reaching the eye 201 of the user.

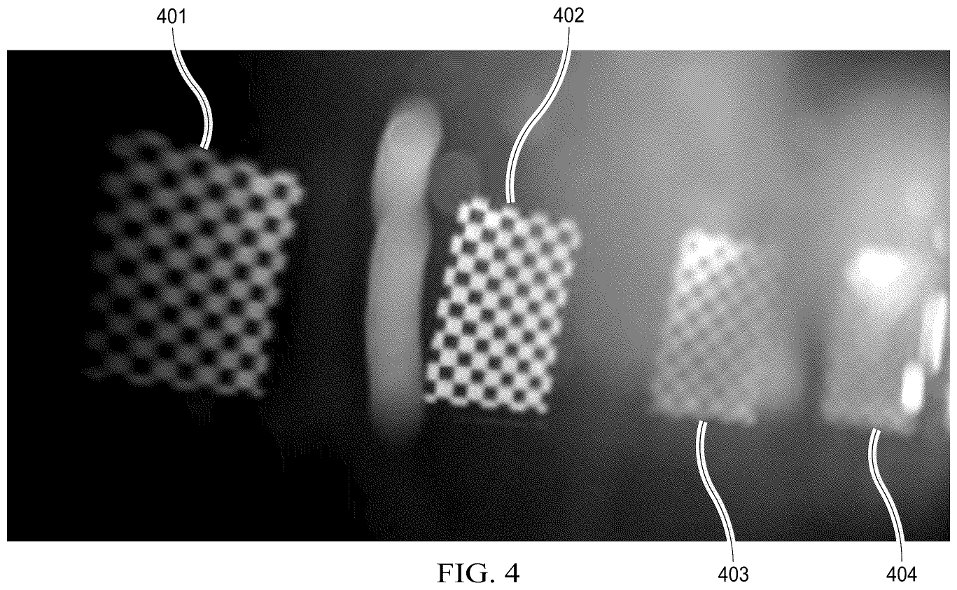

FIG. 4 illustrates a representative series of perceived images resulting from successive PIR interactions with the eye-facing surface 215 described with respect to the curved lightguide 200 of FIG. 3. In particular, and with reference to both FIGS. 3 and 4, the portion 301 of display light 307 outcoupled from the lightguide 200 after the eleventh site of reflective interaction (that associated with a 5.2° angle of incidence) forms an intended perceived primary image 401; however, the portions 302, 303, 304 of display light 307 lost (that is, exiting the lightguide 200) after each additional PIR reflective interaction with the eye-facing surface 215—i.e., those reflective interactions associated with a respective angle of incidence less than the critical angle of the lightguide 200—result in additional instances of that perceived primary image 401 that ‘leak’ from the inefficient PIR interactions along the path of display light 307. In particular, the portion 302 of display light 307 lost via the 11.4° interaction with the eye-facing surface 210 forms a secondary perceived image 402; the portion 303 lost via the 23.5° interaction forms a third perceived image 403; and the portion 304 lost via the 35.5° reflective interaction forms a fourth perceived image 404.

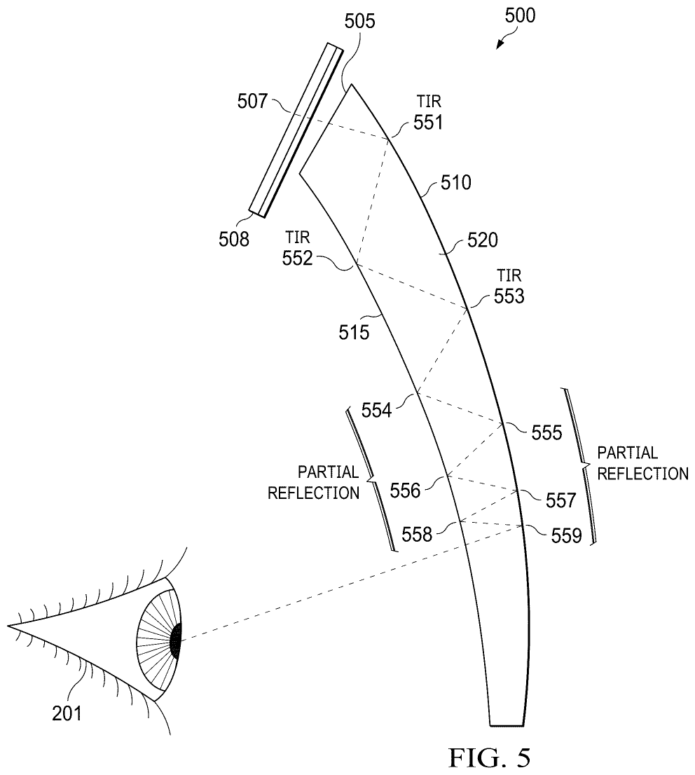

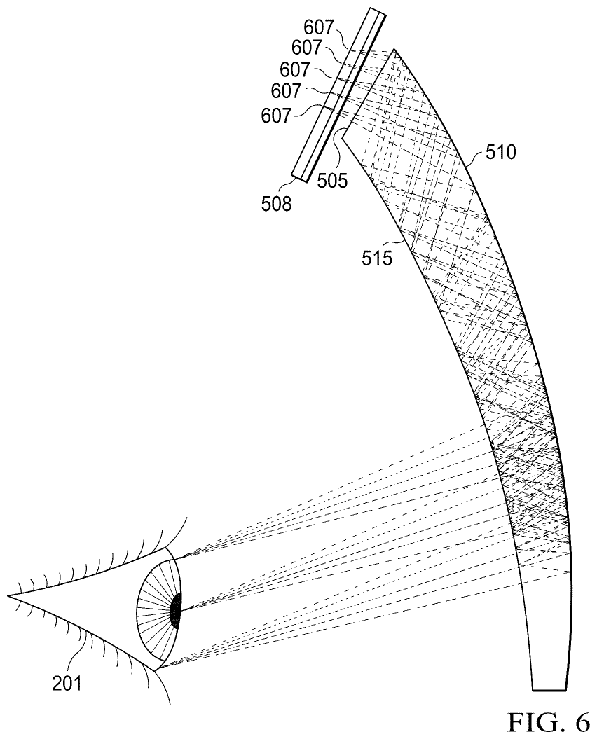

FIGS. 5 and 6 illustrate embodiments of a thin curved lightguide 500 utilizing fewer reflective interactions (bounces) than the curved lightguide 200 in the example of FIGS. 2 and 3. In a manner similar to that described with respect to the curved lightguide 200, the curved lightguide 500 has a world-facing surface 510, an eye-facing surface 515, and a flat incoupler surface 505 that is aligned proximate to a light engine 508 in order to direct display light 507 from the light engine 508 into an internal volume 520 of the curved lightguide 500. However, instead of the light path of an incoming display light traversing eleven reflective interactions in an internal body of the curved lightguide 500 to produce the primary perceived image 401, the curved lightguide 500 is optimized for display of a secondary perceived image (e.g., perceived image 402) such that an incoupler display light 507 encounters only nine reflective interactions during its traversal through an internal volume of the curved lightguide 500, sequentially depicted as internal reflective interactions 551, 552, 553, 554, 555, 556, 557, 558, 559. As shown, reflective interactions 551, 552, 553 occur via TIR within the curved lightguide 500, while reflective interactions 554, 555, 556, 557, 558, 559 occur via only partial internal reflection (PIR). Advantageously, by reducing the number of internal reflective interactions encountered by the display light 507, the optical efficiency of the curved lightguide 500 is improved by virtue of experiencing fewer instances of external loss due to PIR interactions.

In certain embodiments, in a manner similar to optical coatings 350 and 360 of FIG. 3, the curved lightguide 500 may comprise one or more optical coatings (not shown) to provide at least partial reflectivity for at least a subset of reflective interactions with the display light 507 and one or both of the world-facing surface 510 and the eye-facing surface 515. For example, in some embodiments an outer optical coating may be disposed to cover a portion of the world-facing surface 510 that is selected based on a critical angle associated with the internal volume 520 of the curved lightguide 500, such as to encompass the sites of PIR reflective interactions 555, 557, and 559. Similarly, in some embodiments an inner optical coating may be disposed to cover a portion of the eye-facing surface 515 that is selected based on the associated critical angle of the internal volume 520, such as to encompass the sites of PIR reflective interactions 554, 556, and 558.

FIG. 6 illustrates a full-field representation of display light 607 being conveyed via the curved lightguide 500. In the depicted embodiment, the surface of world-facing surface 510 is a spherical reflective surface; the surface of eye-facing surface 515 is a freeform reflective surface; and the flat incoupler surface 505 of the curved lightguide 500, through which display light 607 is input by light engine 508, is a substantially planar reflective surface. Light engine 508 directs multiple display lights 607 into the internal volume 520 of the curved lightguide 500 via the flat incoupler surface 505. The display lights 607 are depicted as a set of disparate light beams (such as provided by individual pixels of a graphical display provided by the light engine 508) spaced positionally to represent a full field of light paths taken by the display light 607 as its light beams traverse and exit the internal volume 520 toward the user's eye 201. The curved lightguide 500 is implemented in a wearable heads-up display or other display system, such as the display system 100 of FIG. 1.

Although not shown in the example of FIG. 6, in some embodiments additional optical components are included in optical paths between the light engine 208 and the incoupler surface 205, or between the eye-facing surface 515 and the eye 201 (e.g., in order to shape the light for viewing by the eye 201). For example, in some embodiments, a prism (not shown) is used to steer light from the light engine into the incoupler surface 505 so that display light 607 is coupled into the internal volume 520 at an angle appropriate to encourage propagation of the display light through the curved lightguide 500 via TIR and/or PIR.

In some embodiments, a substantially transparent optical compensation shell may be coupled to a non-planar lightguide (e.g., the curved lightguide 200 of FIGS. 2-3 or curved lightguide 500 of FIGS. 5-6) in order to correct optical aberrations of world-side light passing through the lightguide.

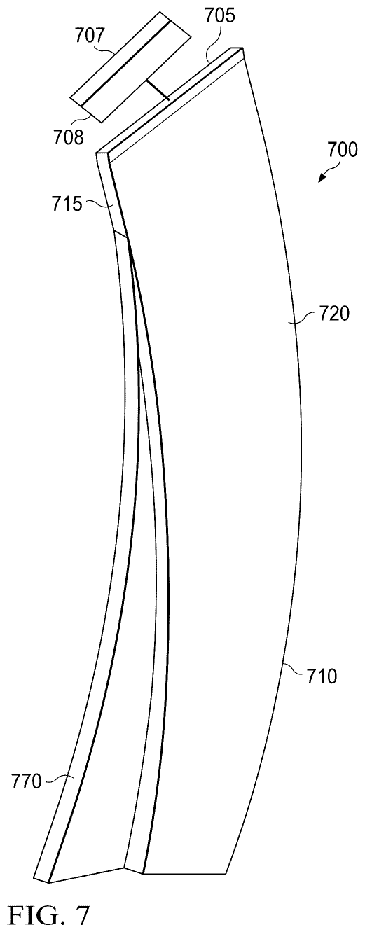

FIG. 7 shows an example of a substantially transparent optical compensation shell 770 that is coupled to an eye-facing surface 715 of a curved lightguide 700, which is configured to direct a display light 707 via an internal volume 720 of the curved lightguide 700 to a user's eye (not shown). In the depicted embodiment, the optical compensation shell 770 is a 5 mm thick optical shell (e.g., a Zeonex E48-R optical compensation shell) at its widest point. In some embodiments, the optical compensation shell 770 has a world-side radius of 91.74 mm and an eye-side radius of 90 mm, which yields few or no aberrations to line of sight and approximately 2 arcminutes of blur at a viewing angle of approximately 30 degrees (close to a maximum comfortable motion for the human eye). At approximately 45 degrees, the associated blur is approximately 7.5 arcminutes. In certain embodiments, the optical compensation shell 770 is adhered to the curved lightguide 700 via a low-index optical adhesive. In certain embodiments, the optical compensation shell 770 may be coupled to world-facing surface 710.

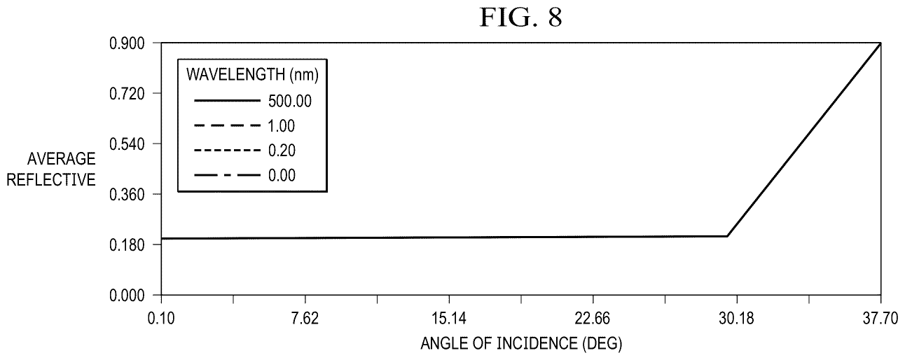

FIG. 8 illustrates a correspondence between angle of incidence and angle of reflectance of an example optical coating (such as may be utilized as optical coating 350 and/or optical coating 360 of FIG. 3, or as an optical coating for any of the curved lightguides of FIGS. 2-3 and 5-7) applied to a curved lightguide, such as one or more embodiments of any of the curved lightguides of FIGS. 2-3 and 5-7 (curved lightguides 200, 500, 700). As shown, the optical coating has a substantially constant average reflectance over a first range of angles of incidence, with that average reflectance increasing over a second higher range. Thus, the optical coating increasingly reflects more light for higher angles of incidence, which effectively extends the TIR critical angle range of a curved lightguide on which the optical coating is disposed. However, within the extended critical angle range, reflection will not be 100% efficient, unlike true TIR, and will be limited to the coating's efficiency in that angle of incidence range. According to various embodiments, the coating is implemented using one or more dielectrics, metals, or combinations of dielectrics and metals.

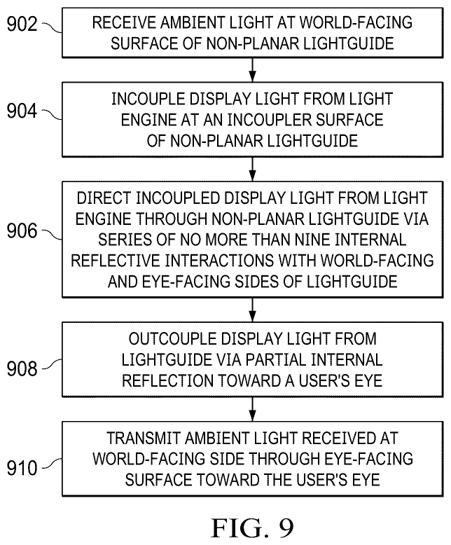

FIG. 9 is a flow diagram of a method 900 of transmitting ambient light through a world-facing surface and an eye-facing surface of a non-planar lightguide while directing display light received from a light engine through the lightguide toward the eye of a user. In some embodiments, the method 900 is performed at least in part by an embodiment of the curved lightguides 200, 500, and 700 of FIGS. 2-3 and 5-7 and display system 100 of FIG. 1.

At block 902, a wearable display system employing a non-planar lightguide receives ambient light at a world-facing surface of the non-planar lightguide. At block 904, light from a light engine (e.g., light engine 208 of FIGS. 2-3, light engine 508 of FIGS. 5-6, or light engine 708 of FIG. 7) is incoupled to the non-planar lightguide by an incoupler surface aligned at a proximate end of the non-planar lightguide. At block 906, the incoupled display light is directed from the light engine through an internal volume of the non-planar lightguide via a series of respective internal reflective interactions with the world-facing and eye-facing surfaces of the non-planar lightguide.

At block 908, the display light is outcoupled from the non-planar lightguide via partial internal reflection toward a user's eye. At block 910, the ambient light that was received at the world-facing surface is transmitted through the eye-facing surface toward the user's eye. It should be noted that blocks 902 and 910 occur substantially simultaneously with blocks 904, 906, and 908.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A head-mounted display device comprising:
a light engine to generate a display light; and
a non-planar lightguide having a world-facing surface, an eye-facing surface, and an incoupler surface proximate the light engine to receive the generated display light into a volume of the non-planar lightguide;
wherein the non-planar lightguide is to direct the generated display light from the incoupler surface to an eye of a user via a series of no more than nine internal reflective interactions of the display light with the world-facing surface and/or the eye-facing surface of the non-planar lightguide.

2. The head-mounted display device of claim 1, wherein the series of internal reflective interactions includes a first number of total internal reflection (TIR) interactions with the world-facing surface and/or the eye-facing surface and a second number of partial internal reflection (PIR) interactions with the world-facing surface and/or the eye-facing surface.

3. The head-mounted display device of claim 1, further comprising one or more optical coatings on one or more of a portion of the eye-facing surface or a portion of the world-facing surface, the one or more optical coatings to increase at least a partial reflectivity for a subset of the no more than nine internal reflective interactions.

4. The head-mounted display device of claim 1, wherein the one or more optical coatings include an inner optical coating on a portion of the eye-facing surface to increase a reflectivity for a subset of the no more than nine internal reflective interactions that occur via partial internal reflection (PIR) at the portion of the eye-facing surface, and wherein the portion of the eye-facing surface is selected based at least in part on a refractive index of the non-planar lightguide.

5. The head-mounted display device of claim 4, wherein the inner optical coating has a first average reflectance over a first range of angles of incidence and a second average reflectance that increases over a second range of angles of incidence, wherein angles of incidence of the second range of angles of incidence are higher than those of the first range of angles of incidence.

6. The head-mounted display device of claim 1, wherein the one or more optical coatings include an outer optical coating on a portion of the world-facing surface to increase a reflectivity for a subset of the no more than nine internal reflective interactions that occur via partial internal reflection (PIR) at the portion of the world-facing surface, the portion of the world-facing surface based on a refractive index of the non-planar lightguide.

7. The head-mounted display device of claim 1, further comprising a substantially transparent optical compensation shell coupled to the non-planar lightguide, the substantially transparent optical compensation shell to correct optical aberrations of world-side light passing through the non-planar lightguide.

8. The head-mounted display device of claim 7, wherein the substantially transparent optical compensation shell is coupled to a surface of the non-planar lightguide with an optically clear adhesive.

9. The head-mounted display device of claim 1 wherein the incoupler surface is a substantially planar surface without an optical incoupler structure.

10. The head-mounted display device of claim 1, wherein to direct the generated display light from the incoupler surface to the eye of a user includes to outcouple the display light from the non-planar lightguide via partial internal reflection and without an outcoupling optical structure on the eye-facing surface.

11. A method, comprising:
receiving ambient light at a world-facing surface of a non-planar lightguide;
coupling display light generated at a light engine into the non-planar lightguide;
directing the display light towards an eye of a user through a volume of the non-planar lightguide via a series of no more than nine internal reflective interactions with a world-facing surface and an eye-facing surface of the non-planar lightguide; and
transmitting the ambient light through the eye-facing surface toward the eye of the user.

12. The method of claim 11, wherein directing the display light via the series of internal reflective interactions includes directing the display light via a first number of total internal reflection (TIR) interactions with the world-facing surface and/or the eye-facing surface and via a second number of partial internal reflection (PIR) interactions with the world-facing surface and/or the eye-facing surface.

13. The method of claim 11, further comprising disposing one or more optical coatings on one or more of a portion of the eye-facing surface or a portion of the world-facing surface, the one or more optical coatings to increase at least a partial reflectivity for a subset of the no more than nine internal reflective interactions.

14. The method of claim 13, wherein disposing the one or more optical coatings includes disposing an inner optical coating on a portion of the eye-facing surface to increase a reflectivity for a subset of the no more than nine internal reflective interactions that occur via partial internal reflection (PIR) at the portion of the eye-facing surface, the portion of the eye-facing surface being selected based at least in part on a refractive index of the non-planar lightguide.

15. The method of claim 14, wherein disposing the inner optical coating includes disposing an inner optical coating having a first average reflectance over a first range of angles of incidence and a second average reflectance that increases over a second range of angles of incidence, the angles of incidence of the second range of angles of incidence being higher than those of the first range of angles of incidence.

16. The method of claim 11, wherein disposing the one or more optical coatings includes disposing an outer optical coating on a portion of the world-facing surface to increase a reflectivity for a subset of the no more than nine internal reflective interactions that occur via partial internal reflection (PIR) at the portion of the world-facing surface, the portion of the world-facing surface being based on a refractive index of the non-planar lightguide.

17. The method of claim 11, further comprising correcting optical aberrations of world-side light passing through the non-planar lightguide by coupling a substantially transparent optical compensation shell to the non-planar lightguide.

18. The method of claim 17, wherein coupling the substantially transparent optical compensation shell to the non-planar lightguide includes adhering the substantially transparent optical compensation shell to a surface of the non-planar lightguide with an optically clear adhesive.

19. The method of claim 11, wherein coupling the display light into the non-planar lightguide includes coupling the display light into the non-planar lightguide via a substantially planar surface without an optical incoupler structure.

20. The method of claim 11, wherein directing the generated display light to the eye of the user includes outcoupling the display light from the non-planar lightguide via partial internal reflection without an outcoupler optical structure on the eye facing surface.
